(19) United States
(12) Patent Application Publication
(10) Pub. No.: US 2006/0019562 A1
(43) Pub. Date: Jan. 26, 2006

(54) Water and stain repellent ''barrier'' substrate

(76) Inventor: Larry Ervin Rising, Kernersville, NC (US)

Correspondence Address: Larry Rising, 3820 Firestone Rd., Kernersville, NC, 27284, US

(21) Appl. No.: 10/896,854

(22) Filed: Jul. 23, 2004

(51) Int. Cl. B32B 27/04; D04H 1/00; B32B 27/12; B32B 25/10; D04H 1/46

(52) U.S. Cl. 442/88; 442/394; 442/327; 442/399; 442/402

(57) ABSTRACT

The present invention provides a multi-layered 3-ply, lightweight barrier substrate with two (optionally anti-microbial and waterproof) fabrics laminated together with a film providing both adhesion and a barrier. Various processes may make water repellant textile fabrics. The term “Barrier Substrate” as used herein means essentially impermeable to water, i.e. can support a considerable column of water without water penetration through the fabric. Such behavior is sometimes termed “water resistant.”The second layer providing the barrier can be either urethane (preferred), polyester or an acrylic material which can be a breathable, or non-breathable film. Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the specification and claims.

### PRIORITY CLAIM

This application claims the benefit of priority to provisional application No. 60/486,668, filed in the United States on Jul. 12, 2003, and titled “Method and Apparatus to Create Laminated Barrier Substrates for Home Fabrics and Upholstery”.

### BACKGROUND OF INVENTION

A waterproof and stain repellent barrier substrate with antimicrobial properties for fabric to be used in furniture, wall coverings and medical applications as well as other applications wherein a barrier substrate is required. The fabric sheet is a three layer laminated waterproof cloth, light in weight, absorbent and optionally antimicrobial, and very durable. The first top layer comprises a material made from man made or natural fibers.

The second layer can be a urethane film ranging from 0.001 inch in thickness to 0.08 inch in thickness. The bottom or third layer is with a needle punch or non-woven fabric or a high loft batting soaker made from rayon fibers, polyester fibers and/or cotton fibers being needle punched into a nonwoven polyester or polypropylene scrim material or high loft batting. An optional forth layer would be an adhesive film, coating or webbing between the first two layers and/or second and third layer to add lamination strength where needed. The layered substrate when treated and laminated with heat and pressure provides a lightweight barrier substrate with natural texture and soft hand.

### REFERENCES CITED

### U.S. Patent Documents

U.S. Pat. No. 4,525,409 June, 1985 Elesh.

U.S. Pat. No. 4,632,860 December, 1986 D'Antonio et al.

U.S. Pat. No. 4,772,281 September, 1988 Armstead 604/358.

U.S. Pat. No. 5,283,112 February, 1994 Krishnan.

U.S. Pat. No. 5,306,536 April, 1994 Moretz et al.

U.S. Pat. No. 5,391,418 February, 1995 Strongwater 428/171.

U.S. Pat. No. 5,514,459 May., 1996 Blaueretal.

U.S. Pat. No. 5,527,600 June, 1996 Frankosky et al.

U.S. Pat. No. 5,565,265 October, 1996 Rubin et al.

U.S. Pat. No. 5,631,074 May., 1997 Herlihy, Jr.

U.S. Pat. No. 5,677,028 October, 1997 Ravella 428/102.

U.S. Pat. No. 5,747,392 May 5, 1998 Rubin

Foreign Patent Documents

| 0541206B1 | October, 1999 | EP. |
|---|---|---|
| 1339859 | December, 1973 | GB. |
| WO 80/01031 | May, 1980 | WO. |
| 9729909 | August, 1997 | WO. |

Other References Cites:

U.S. patent Publication No. US-2004-006827-A1, Dated Jan. 15, 2004

U.S. patent application Ser. No. 10/611,746, Dated Jun. 30, 2003

### SUMMARY OF THE INVENTION

The present invention relates to an improved waterproof barrier fabric useful for furniture, wall covering, and medical applications with optional antimicrobial properties.

It is a principal object of the invention to provide a waterproof fabric consisting of a three layer laminated fabric. Top layer being a textile (woven or knit) substrate. Second layer being a urethane film and bottom layer being a non-woven material. The second layer provides the dual function of adhesive and barrier.

It is another object of the invention to provide a waterproof stain repellent fabric comprising a top layer of a material selected from the group consisting of man made fibers and natural fibers and mixtures thereof treated to be water and stain repellent with fluorocarbons as outline in U.S. Pat. No. 5,747,392 patent or U.S. patent application Ser. No. 10/611,746, Dated Jun. 30, 2003.

It is yet another object of the invention to provide a waterproof fabric with a third layer comprising a sheet material selected from the group consisting of man made or natural fibers of either a batting, needle punch, knitted or woven material.

### DETAILED DESCRIPTION OF THE PREFERRED EMBODIMENT

The present invention relates generally to an improved 3-ply waterproof barrier fabric useful for furniture upholstery, wall coverings, restaurant table coverings and medical applications. The three layers are laminated by being made to come in continuous contact, and while in contact, pressure is applied between a blanket and a roller. The pressure is about 50 lbs/in.sup.2 (34 N/cm.sup.2) to about 60 lbs/in.sup.2 (41 N/cm.sup.2), with 60 lbs/in.sup.2 (41 N/cm.sup.2) preferred. Heat is also applied at about 380. degree. F. to about 430. degree. F. (193. degree. C. to 221. degree. C.), preferably at 420. degree. F. (216. degree. C.). The dwell time, (15 to 30 sec.) or time where heat and/or pressure are applied, is a time sufficient for the urethane film to become soft enough to provide bonding but not losing its ability to provide a barrier to liquid supporting a column of water. Those skilled in the art will know other methods to laminate the three layers as there are any number of ways and the above merely representative of one method.

### DESCRIPTION OF THE RELATED ART

The related art of interest describes various waterproof fabrics for outdoor and indoor use. None of the related art addresses the need for a light weigh low cost barrier substrate. This barrier product is now produced by applying multiple coatings of acrylic copolymers to a substrate treated with fluorocarbons. The method requires multiple passes through very large energy consuming dryers that are polluting the environment. In addition to being very expensive the current method produces a very heavy and stiff product. By this invention a lightweight more durable product can be produced at half the energy now required.
U.S. Pat. No. 5,283,112 issued on Feb. 1, 1994, to Sundaram Krishnan describes the making of waterproof breathable fabric laminates from a polyurethane membrane bonded between woven or non-woven nylon fabric layers and the products useful for tenting and rainwear. The waterproof polyurethane added product is distinguishable for its emphasis on being breathable and mostly limited to polyurethane compounds which would not be suitable for a barrier product as in this present invention.
U.S. Pat. No. 5,527,600 issued on Jun. 18, 1996, to Michael S. Frankosky et al. describes a bonded polyester fiberfill batting with a sealed outer surface by coating with an acrylic resin. The batting is useful for filling pillows, cushions, bedding materials, and in apparel. The batting is distinguishable for its non-laminated structure.
U.S. Pat. No. 5,565,265 issued on Oct. 15, 1996, to Craig A Rubin et al. describes a liquid and stain resistant antimicrobial fabric made by repeatedly coating a polyester fabric in separate steps with an aqueous composition containing an acrylic copolymer, a fluorochemical and a biocide/mildewed. The antimicrobial agents disclosed are hereby incorporated by reference. The antimicrobial fabric is distinguishable for its limitation to a single coated substrtate.
U.S. Pat. No. 4,525,409 issued on Jun. 25, 1985, to James N. Elesh describes a tightly woven nylon or polyester treated fabric for producing bedding fabrics. The tightly woven taffeta or ripstop weave cloth is coated with a urethane water repellant, a bacteriostatic and fungistatic agent, a fire retardant, and an anti-static agent. The antimicrobial compositions are incorporated by reference. The fabric is distinguishable by the addition of a plurality of agents to the single layer of the tightly woven fabric.
U.S. Pat. No. 4,632,860 issued on Dec. 30, 1986, to John P. D'Antonio et al. describes a waterproof, moisture-breathable, non-macerating, and hypoallergenic fabric by coating a substrate layer containing natural or synthetic fibers with a basecoat of an acrylic polymer and pigment, and a topcoat of either polyether urethane or silicone latex. The fabric is distinguishable for being a single coated layer.
U.S. Pat. No. 5,631,074 issued on May 20, 1997, to Daniel J. Herlihy, Jr. describes a two- or three-layer waterproof breathable fabric for outdoor athletic apparel comprising a shell fabric having a blend of polypropylene filaments and spandex fibers, a waterproof membrane of a copolyether ester laminated to the shell fabric, and optionally, a crepe or mesh lining. A silicone coating may be applied on the shell fabric. The fabric is distinguishable for its waterproofing elastic quality used for a surfer dry suit and not be suitable for a barrier product as in the present invention.
U.S. Pat. No. 5,306,536 issued on Apr. 6, 1994, to Herbert L. Moretz et al. describes a multi-layer moisture management fabric comprising four layers for making undergarments for incontinent people. The shell fabric is conventional undergarment material, the second layer is a thick hydrophilic storage layer of nylon fibers, the third layer is a thin nylon transport layer, and the fourth innermost layer is a knitted or woven hydrophobic polyester layer. The third and fourth layers can be combined. The fabric is distinguishable for its lack of cohesiveness between layers as required in the present invention.
U.S. Pat. No. 5,514,459 issued on May 7, 1996, to Stephen J. Blauer et al. describes a waterproof breathable lining for outerwear comprising a shell fabric of a plain weave of nylon, acrylic or polyester which is printed with a pattern of a terpolymer containing 12-30% urethane, 1% silicone and the remainder being acrylic. The terpolymer pattern is impregnated with a fluorocarbon release agent. The lining includes an intermediate outer synthetic polymer membrane (polyurethane, polyester ether and/or polytetrafluoroethylene), an inner synthetic polymer fabric (nylon or polyester weave or knit), and optionally, an outer synthetic polymer fabric (nylon or polyester weave or knit). The four- or five-layer shell fabric and lining composition would not be suitable for a barrier product as in the present invention.
P.C.T. Patent Application No. WO 80/01031 published on May 15, 1980, for Frankosky describes a fiberfill blend for thermal insulation in garments comprising 70-90% crimped polyester staple fiber (polyethylene terephthalate) and 10-30% crimped staple binder fiber (ethylene terephthalate/ethylene isophthalate copolyester with 25-75 wt. % slickened with a cured polysiloxane. The fiberfill blend is distinguishable for its emphasis on thermal quality rather than waterproofing.
None of the above inventions and patents, taken either singularly or in combination, is seen to describe the present invention as claimed. Thus, a waterproof barrier fabric which is light in weight, economical, and multi-ply is desired.

What is claimed is:

1. A waterproof and stain repellent three-ply fabric composition comprising of:
(a) a first top layer of a fabric selected from the group consisting of polyester, cotton, and polyester cotton blends treated with fluorocarbon formulas, being water or solvent based, to provide a water and stain repellent top layer. Example—as cited in U.S. Pat. No. 5,747,392 and U.S. patent Publication No. US-2004-0006827-A1.
(b) a second layer being an impervious urethane film between the outer layer and the back layer providing an impervious barrier and also providing the adhesive or bonding of the top layer to the bottom layer when heat and pressure are properly applied as described in this application.
(c) a needle punch or non-woven fabric for the third or back layer or a high loft batting material made from rayon fibers, polyester fibers and/or cotton fibers being needle punched into a non-woven polyester or polypropylene scrim or other substrates suitable for backing material and being bonded to said first layer by a urethane film (second layer).

2. The fabric composition according to claim 1, with first or top and/ bottom or third or back layers having antimicrobial fibers.

3. The fabric composition according to claim 1, with first or top layer having polyester fibers and/or other man made fibers or blends of man made fibers.

4. The fabric composition according to claim 1, with first or top layer having greater than 40% cotton fibers and being bonded to said second layer by a urethane glue.

5. The fabric composition according to claim 1, with first or top layer having a blend of polyester and cotton fibers or rayon and polyester blend or any combination of man made and natural fibers.

6. The fabric composition according to claim 1, with second layer being a urethane film at 0.001 to 0.003 inch thickness.

7. The fabric composition according to claim 1, with second layer being a urethane film with an adhesive webbing or adhesive coating added to increase bonding between top and second layer and/or between second and bottom layer.

8. The fabric composition according to claim 1, with second layer being a urethane film greater than 0.003 inch thickness.

9. The fabric composition according to claim 1, with second layer providing an imperious barrier to prevent liquid from passing through the substrate.

10. The fabric composition according to claim 1, where second layer also servers the double duty as barrier and bonding adhesive for the top and back layers.

11. The fabric composition according to claim 1, wherein said third layer is polyester.

12. The fabric composition according to claim 1, wherein said third layer is acrylic.

13. The fabric composition according to claim 1, wherein said third layer is needle punch batting.

14. The fabric composition according to claim 1, wherein said third layer is high loft batting.

15. The fabric composition according to claim 1, wherein said third layer having polyester fibers punched into said batting or needle punch material.

16. The fabric composition according to claim 1, wherein said third layer having rayon fibers needle punched into said needle punch material.

17. The fabric composition according to claim 15, wherein said third layer having cotton and polyester fibers needle punched into said needle punch material.

18. The fabric composition according to claim 15, Wherein said third layer having a mixture of rayon fibers, polyester fibers and cotton fibers needle punched into said needle punch material.

19. The fabric composition according to claim 15, Wherein said third layer being treated with fluorocarbons to provide water and stain repellent backing.

20. A three layer composite fabric comprising:
a) a first outer layer of a woven or knit fabric;
b) a second layer of a waterproof, film, one side of film being bonded to top layer and the other side being bonded to the third or bottom non-woven layer.
